(19) United States
(12) Patent Application Publication
(10) Pub. No.: US 2018/0182318 A1
(43) Pub. Date: Jun. 28, 2018

(54) LIQUID CRYSTAL DEVICES AND METHODS OF ENHANCING COLOR SHIFT OF LIQUID CRYSTAL DEVICES

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Zhenzhou XING, Shenzhen, Guangdong (CN); Xiaoping TAN, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei, (CN)

(21) Appl. No.: 15/304,487

(22) PCT Filed: Aug. 15, 2016
(86) PCT No.: PCT/CN2016/095203

§ 371 Date: Oct. 14, 2016

(30) Foreign Application Priority Data
Jun. 7, 2016 (CN) 201610399089.2

(51) Int. Cl. G09G 3/36

(52) U.S. Cl. CPC G09G 3/3607; G09G 3/3677; G09G 2320/0673; G09G 2320/0242; G09G 3/3688

(57) ABSTRACT

The present disclosure relates to a liquid crystal device (LCD) and a method of enhancing color shift of LCDs. The method includes: dividing a sub-pixel of pixels of a liquid crystal panel into a first portion and a second portion, and a dimension of the first portion is greater than that of the second portion; configuring an applied state of gate driving signals of gate lines connected to the first portion and the second portion of the sub-pixel and configuring an output voltage of data lines connected to the first portion and the second portion of the sub-pixel, such that a grayscale of the first portion is greater than the grayscale of the second portion; and mixing the grayscales of the first portion and the second portion such that a squint angle GAMMA curve of the LCD is close to a straight angle GAMMA curve of the LCD so as to enhance the color shift.

### BACKGROUND OF THE INVENTION

### 1. Field of the Invention

The present disclosure relates to liquid crystal display technology, and more particularly to a liquid crystal device (LCD) and a method of enhancing color shift of LCDs.

### 2. Discussion of the Related Art

LCDs are characterized by attributes such as small dimension, light, low power consumption, and high display performance, and thus are very popular. The driving principle of the LCD relates to configuring the voltage of the electrodes at two ends of the liquid crystal layer such that the rotating angle of the liquid crystal molecules may be adjusted, which controls the amount of the light beams passing through the liquid crystal panel. The GAMMA curves of the thin film transistor (TFT) LCD may be different under a straight angle and a squint angle condition. That is, color shift may occur under the straight angle condition. The color shift may result in whitening display effect. To enhance the optical performance of the TFT LCD, the color shift issue has to be overcome.

Currently, the sub-pixel is divided into a first portion and a second portion, and the portions are applied with equal voltage via a gate line. Afterward, a portion of the voltage applied to the second portion is released through another gate line, such that a voltage difference is formed between the first portion and the second portion. That is, one is of high grayscale and the other one is of low grayscale, and the high grayscale and the low grayscale are mixed to generate a middle grayscale. The above process may result in that the GAMMA curve in a squint angle condition is close to the GAMMA curve in a straight angle condition, such that the color shift may be enhanced. Nevertheless, the enhanced performance is not ideal enough. In addition, due to the discharge process of the second portion, it can be understood that a longer charge-discharge period may be required.

### SUMMARY

To overcome the above problem, a LCD and a method are proposed to enhance the color shift of the LCD caused by the squint angle.

In one aspect, a method of enhancing color shift of liquid crystal device (LCD) caused by squint angle includes: dividing a sub-pixel of pixels of a liquid crystal panel into a first portion and a second portion, and a dimension of the first portion is greater than that of the second portion; configuring an applied state of gate driving signals of gate lines connected to the first portion and the second portion of the sub-pixel and configuring an output voltage of data lines connected to the first portion and the second portion of the sub-pixel, such that a grayscale of the first portion is greater than the grayscale of the second portion; and mixing the grayscales of the first portion and the second portion such that a squint angle GAMMA curve of the LCD is close to a straight angle GAMMA curve of the LCD so as to enhance the color shift.

Wherein the gate driving signals are applied to the first portion and the second portion of the sub-pixel via the gate line connected to the first portion and the second portion of the sub-pixel, a first voltage is applied to the first portion of the sub-pixel via a first data line connected to the first portion of the sub-pixel, a second voltage is applied to the second portion of the sub-pixel via a second data line connected to the second portion of the sub-pixel, and the first voltage is higher than the second voltage, such that the grayscale of the first portion is greater than the grayscale of the second portion.

Wherein the first voltage and the second voltage are generated by a source driver of the LCD, and the source driver respectively provides the first voltage and the second voltage to the first data line and the second data line.

Wherein the gate driving signals are applied toward the first portion of the sub-pixel by a first gate line connected to the first portion of the sub-pixel for a first duration, and the gate driving signals are applied toward the second portion of the sub-pixel by a second gate line connected to the second portion of the sub-pixel for a second duration, wherein the first duration is greater than the second duration, the data line connected to the first portion and the second portion of the sub-pixel applies the same voltage to the first portion and the second portion of the sub-pixel, such that the grayscale of the first portion is greater than the grayscale of the second portion of the sub-pixel.

Wherein the source driver of the LCD generates the voltage, and provides the same voltage to the data line.

Wherein the first gate line and the second gate line respectively applies the gate driving signals to the first portion and the second portion of the sub-pixel simultaneously, the second gate line stops applying the gate driving signals to the second portion of the sub-pixel before the first gate line stops applying the gate driving signals to the first portion of the sub-pixel.

In another aspect, a LCD includes: a liquid crystal panel for displaying; a controller configured to: divide a sub-pixel of the liquid crystal panel into a first portion and a second portion, wherein a dimension of the first portion is greater than the dimension of the second portion; configure an applied state of gate driving signals of gate lines connected to the first portion and the second portion of the sub-pixels and configure an output voltage of data lines connected to the first portion and the second portion of the sub-pixels, such that a grayscale of the first portion is greater than the grayscale of the second portion of the sub-pixels; and mix the grayscales of the first portion and the second portion, such that a squint angle GAMMA curve of the LCD is close to a straight angle GAMMA curve of the LCD to enhance color shift of the LCD.

Wherein the gate driving signals are applied to the first portion and the second portion of the sub-pixel via the gate line connected to the first portion and the second portion of the sub-pixel, a first voltage is applied to the first portion of the sub-pixel via a first data line connected to the first portion of the sub-pixel, a second voltage is applied to the second portion of the sub-pixel via a second data line connected to the second portion of the sub-pixel, and the first voltage is higher than the second voltage, such that the grayscale of the first portion is greater than the grayscale of the second portion.

Wherein in response to control of the controller, the gate driving signals are applied toward the first portion of the sub-pixel by a first gate line connected to the first portion of the sub-pixel for a first duration, and the gate driving signals are applied toward the second portion of the sub-pixel by a second gate line connected to the second portion of the sub-pixel for a second duration, wherein the first duration is greater than the second duration, the data line connected to the first portion and the second portion of the sub-pixel applies the same voltage to the first portion and the second portion of the sub-pixel, such that the grayscale of the first portion is greater than the grayscale of the second portion of the sub-pixel.

Wherein in response to the control of the controller, the first gate line and the second gate line respectively applies the gate driving signals to the first portion and the second portion of the sub-pixel simultaneously, the second gate line stops applying the gate driving signals to the second portion of the sub-pixel before the first gate line stops applying the gate driving signals to the first portion of the sub-pixel.

### BRIEF DESCRIPTION OF THE DRAWINGS

Embodiments of the invention will now be described more fully hereinafter with reference to the accompanying drawings, in which embodiments of the invention are shown.

FIG. 1 is a schematic view showing the driving structure of the source driver of LCD in accordance with one embodiment.

FIG. 2 is a flowchart illustrating the method of enhancing the color shift of LCD in accordance with one embodiment.

FIG. 3 is a schematic view showing the method of enhancing the color shift of LCD in accordance with a first embodiment.

FIG. 4 is a schematic view showing the method of enhancing the color shift of LCD in accordance with a second embodiment.

### DETAILED DESCRIPTION OF THE EMBODIMENTS

Various example embodiments will now be described more fully with reference to the accompanying drawings in which some example embodiments are shown. In the drawings, the thicknesses of layers and regions may be exaggerated for clarity. In the following description, in order to avoid the known structure and/or function unnecessary detailed description of the concept of die invention result in confusion, well-known structures may be omitted and/or functions described in unnecessary detail.

FIG. 1 is a schematic view showing the driving structure of the source driver 100 of LCD in accordance with one embodiment.

As shown in FIG. 1, the source driver 100 includes a programmable GAMMA voltage output module 102, a line buffer 104, a level shifter 106, a D/A converter 108, and a buffer 110. The RGB data are input to the line buffer 104, the line buffer 104 transmits the RGB data to the level shifter 106, the level shifter 106 shifts the RGB data, the D/A converter 108 applies a digital-analog conversion to the shifted RGB data. During the digital-analog conversion, the programmable GAMMA voltage output module 102 outputs a GAMMA compensation voltage, including Vr1-Vr5 and Vr6-Vr10, to apply a GAMMA compensation to the RGB data. After the GAMMA compensation and the digital-analog conversion, the RGB data is buffered by the buffer 110. Afterward, the corresponding voltage is outputted to data lines connected with the sub-pixels of the LCD such that the sub-pixels are driven to display.

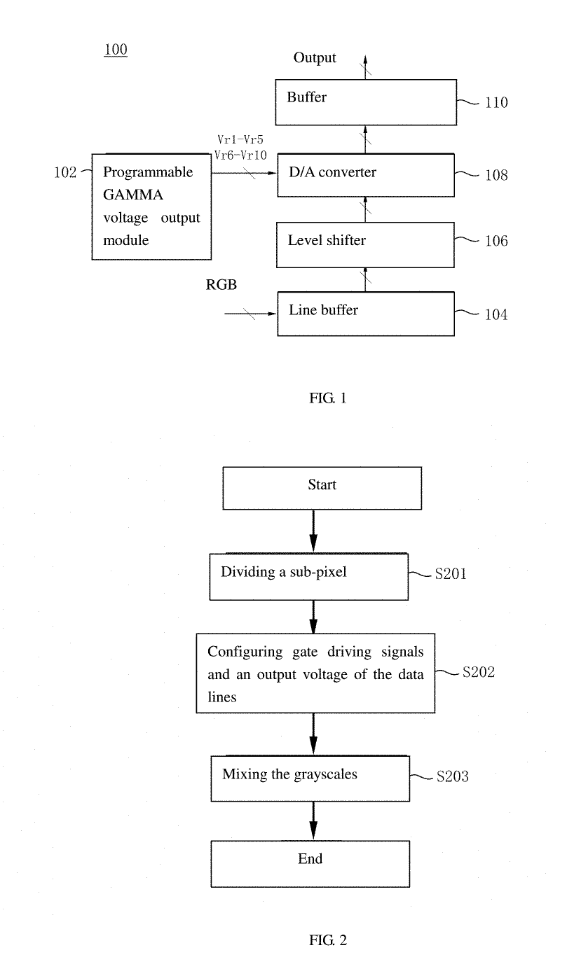

FIG. 2 is a flowchart illustrating the method of enhancing the color shift of LCD in accordance with one embodiment.

As shown in FIG. 2, in step S201, the sub-pixels of the pixels of the LCD are divided into a first portion, i.e., first sub-pixel units, and a second portion, i.e., second sub-pixels units, wherein a dimension of the first portion is greater than that of the second portion. In step S202, configuring an applied state of gate driving signals of the gate lines connected to the first portion and the second portion of the sub-pixels and configuring an output voltage of the data lines connected to the first portion and the second portion of the sub-pixels, an energy, i.e., a grayscale, of the first portion and the second portion of the sub-pixels are different. That is, the grayscale of the first portion is greater than the grayscale of the second portion of the sub-pixels. In other words, the grayscale of the first portion of the sub-pixels is a high grayscale, and the grayscale of the second portion of the sub-pixels is a low grayscale. In step S203, the grayscales of the first portion and the second portion are mixed to be a middle grayscale such that the squint angle GAMMA curve of the LCD is close to the straight angle GAMMA curve of the LCD. As such, the color shift of the LCD is enhanced.

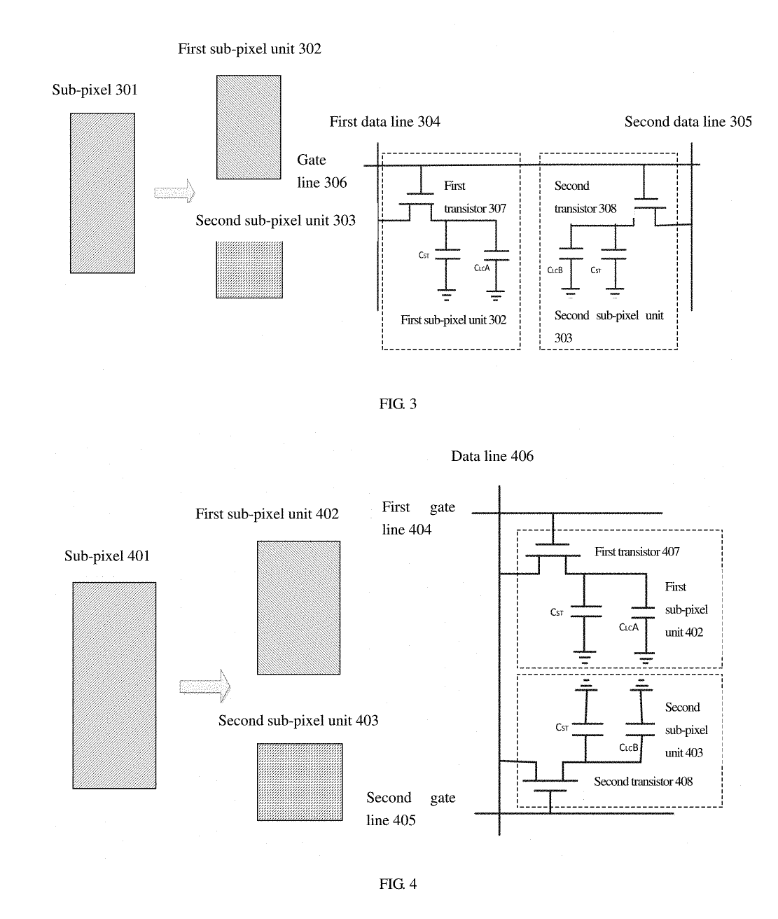

The method of enhancing the color shift of the LCD will be described with reference to FIGS. 3 and 4.

FIG. 3 is a schematic view showing the method of enhancing the color shift of LCD in accordance with a first embodiment.

As shown in FIG. 3, the sub-pixel 301 is divided into a first sub-pixel unit 302 and a second sub-pixel unit 303, wherein the dimension of the first sub-pixel unit 302 is greater than the dimension of the second sub-pixel unit 303. The sub-pixel 301 includes a first transistor 307. A gate of the first transistor 307 connects to a gate line 306, a source of the first transistor 307 connects to a first data line 304, and a drain of the first transistor 307 is grounded. The second sub-pixel unit 303 includes a second transistor 308, a gate of the second transistor 308 connects to the gate line 306, a source of the second transistor 308 connects to a second data line 305, and a drain of the second transistor 308 is grounded. The gate driving signals may be applied to the gate of the first transistor 307 and the second transistor 308 via the gate line 306 connected to the first sub-pixel unit 302 and the second sub-pixel unit 303. A first voltage may be applied to the source of the first transistor 307 via the first data line 304, and the first voltage is generated by the source driver 100. A second voltage may be applied to the source of the second transistor 308 via the second data line 305, and the second voltage is generated by the source driver 100, and the second voltage is lower than the first voltage.

When the gate driving signals are the same, as the first voltage is higher than the second voltage, the energy stored within the first sub-pixel unit 302 is higher than that stored within the second sub-pixel unit 303. That is, the grayscale of the first sub-pixel unit 302 is higher than the grayscale of the second sub-pixel unit 303. The middle grayscale may be generated by mixing the high grayscale of the first sub-pixel unit 302 and the low grayscale of the second sub-pixel unit 303 to amend the GAMMA curve under the squint angle condition. As such, the squint angle GAMMA curve of the LCD is close to the straight angle GAMMA curve of the LCD, and thus the color shift of the LCD is enhanced.

FIG. 4 is a schematic view showing the method of enhancing the color shift of LCD in accordance with a second embodiment.

As shown in FIG. 4, the sub-pixel 401 is divided into a first sub-pixel unit 402 and a second sub-pixel unit 403, wherein the dimension of the first sub-pixel unit 402 is greater than the dimension of the second sub-pixel unit 403. The sub-pixel 401 includes a first transistor 407. A gate of the first transistor 407 connects to a gate line 406, a source of the first transistor 407 connects to a first data line 404, and a drain of the first transistor 407 is grounded. The second sub-pixel unit 403 includes a second transistor 408, a gate of the second transistor 408 connects to the gate line 406, a source of the second transistor 408 connects to a second data line 405, and a drain of the second transistor 408 is grounded.

The gate driving signals may be applied to the first transistor 407 via the first gate line 404 connected to the first sub-pixel unit 402, and the gate driving signals may be applied to the second transistor 408 via the second gate line 405 connected to the second sub-pixel unit 403. The same voltage may be applied to the source of the first transistor 407 and the second transistor 408 via the data line 406, and the voltage is generated by the source driver 100.

When the voltage applied to the source of the first transistor 407 and of the second transistor 408 remains the same, the connection with the second gate line 405 is disconnected. Afterward, the connection with the first gate line 404 is disconnected such that the duration of the gate driving signals connected with first gate line 404 of the first sub-pixel unit 402 is greater than the duration of the gate driving signals connected with the second gate line 405 of the second sub-pixel unit 403.

Under the circumstance, the energy stored within the first sub-pixel unit 402 is higher than that stored within the second sub-pixel unit 403. That is, the grayscale of the first sub-pixel unit 402 is higher than the grayscale of the second sub-pixel unit 403. The middle grayscale may be generated by mixing the high grayscale of the first sub-pixel unit 402 and the low grayscale of the second sub-pixel unit 403 to amend the GAMMA curve under the squint angle condition. As such, the squint angle GAMMA curve of the LCD is close to the straight angle GAMMA curve of the LCD, and thus the color shift of the LCD is enhanced.

According to the present disclosure, a LCD includes a liquid crystal panel (not shown) and a controller (not shown).

The controller may be configured to divide the sub-pixel of the liquid crystal panel into a first portion and a second portion, wherein the dimension of the first portion is greater than the dimension of the second portion. The controller configures an applied state of the gate driving signals of the gate lines connected to the first portion and the second portion of the sub-pixels and configures an output voltage of the data lines connected to the first portion and the second portion of the sub-pixels. As such, the grayscale of the first portion is greater than the grayscale of the second portion of the sub-pixels. The controller mix the grayscales of the first portion and the second portion. Thus, the squint angle GAMMA curve of the LCD is close to the straight angle GAMMA curve of the LCD, and the color shift of the LCD is enhanced.

The controller controls the gate driver (not shown) of the LCD to generate the gate driving signals, and controls the gate driver to provide the gate driving signals to the gate line.

The controller controls the source driver 100 of the LCD to generate the first voltage and the second voltage. In addition, the source driver 100 is controlled to provide the first voltage and the second voltage respectively to the first data line and the second data line.

In response to the control of the controller, the grayscale of the first portion is higher than the grayscale of the second portion, which is similar to the first embodiment and the second embodiment, and thus the corresponding descriptions are omitted hereinafter.

In view of the above, the color shift of the LCD may be effectively enhanced. Thus, the optical performance of the LCD may be also enhanced.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method of enhancing color shift of liquid crystal device (LCD) caused by squint angle, comprising:
dividing a sub-pixel of pixels of a liquid crystal panel into a first portion and a second portion, and a dimension of the first portion is greater than that of the second portion;
configuring an applied state of gate driving signals of gate lines connected to the first portion and the second portion of the sub-pixel and configuring an output voltage of data lines connected to the first portion and the second portion of the sub-pixel, such that a grayscale of the first portion is greater than the grayscale of the second portion; and
mixing the grayscales of the first portion and the second portion such that a squint angle GAMMA curve of the LCD is close to a straight angle GAMMA curve of the LCD so as to enhance the color shift.

2. The method as claimed in claim 1, wherein the gate driving signals are applied to the first portion and the second portion of the sub-pixel via the gate line connected to the first portion and the second portion of the sub-pixel, a first voltage is applied to the first portion of the sub-pixel via a first data line connected to the first portion of the sub-pixel, a second voltage is applied to the second portion of the sub-pixel via a second data line connected to the second portion of the sub-pixel, and the first voltage is higher than the second voltage, such that the grayscale of the first portion is greater than the grayscale of the second portion.

3. The method as claimed in claim 2, wherein the first voltage and the second voltage are generated by a source driver of the LCD, and the source driver respectively provides the first voltage and the second voltage to the first data line and the second data line.

4. The method as claimed in claim 1, wherein the gate driving signals are applied toward the first portion of the sub-pixel by a first gate line connected to the first portion of the sub-pixel for a first duration, and the gate driving signals are applied toward the second portion of the sub-pixel by a second gate line connected to the second portion of the sub-pixel for a second duration, wherein the first duration is greater than the second duration, the data line connected to the first portion and the second portion of the sub-pixel applies the same voltage to the first portion and the second portion of the sub-pixel, such that the grayscale of the first portion is greater than the grayscale of the second portion of the sub-pixel.

5. The method as claimed in claim 4, wherein the source driver of the LCD generates the voltage, and provides the same voltage to the data line.

6. The method as claimed in claim 4, wherein the first gate line and the second gate line respectively applies the gate driving signals to the first portion and the second portion of the sub-pixel simultaneously, the second gate line stops applying the gate driving signals to the second portion of the sub-pixel before the first gate line stops applying the gate driving signals to the first portion of the sub-pixel.

7. A LCD, comprising:
a liquid crystal panel for displaying;
a controller configured to:
divide a sub-pixel of the liquid crystal panel into a first portion and a second portion, wherein a dimension of the first portion is greater than the dimension of the second portion;
configure an applied state of gate driving signals of gate lines connected to the first portion and the second portion of the sub-pixels and configure an output voltage of data lines connected to the first portion and the second portion of the sub-pixels, such that a grayscale of the first portion is greater than the grayscale of the second portion of the sub-pixels; and
mix the grayscales of the first portion and the second portion, such that a squint angle GAMMA curve of the LCD is close to a straight angle GAMMA curve of the LCD to enhance color shift of the LCD.

8. The LCD as claimed in claim 7, wherein the gate driving signals are applied to the first portion and the second portion of the sub-pixel via the gate line connected to the first portion and the second portion of the sub-pixel, a first voltage is applied to the first portion of the sub-pixel via a first data line connected to the first portion of the sub-pixel, a second voltage is applied to the second portion of the sub-pixel via a second data line connected to the second portion of the sub-pixel, and the first voltage is higher than the second voltage, such that the grayscale of the first portion is greater than the grayscale of the second portion.

9. The LCD as claimed in claim 7, wherein in response to control of the controller, the gate driving signals are applied toward the first portion of the sub-pixel by a first gate line connected to the first portion of the sub-pixel for a first duration, and the gate driving signals are applied toward the second portion of the sub-pixel by a second gate line connected to the second portion of the sub-pixel for a second duration, wherein the first duration is greater than the second duration, the data line connected to the first portion and the second portion of the sub-pixel applies the same voltage to the first portion and the second portion of the sub-pixel, such that the grayscale of the first portion is greater than the grayscale of the second portion of the sub-pixel.

10. The LCD as claimed in claim 9, wherein in response to the control of the controller, the first gate line and the second gate line respectively applies the gate driving signals to the first portion and the second portion of the sub-pixel simultaneously, the second gate line stops applying the gate driving signals to the second portion of the sub-pixel before the first gate line stops applying the gate driving signals to the first portion of the sub-pixel.
